(19) United States
(12) Patent Application Publication
(10) Pub. No.: US 2018/0137712 A1
(43) Pub. Date: May 17, 2018

(54) PAPER SHEET STORAGE CASSETTE AND PAPER SHEET HANDLING MACHINE

(71) Applicant: GLORY LTD., Himeji-shi (JP)

(72) Inventor: Hisashi ISHITOBI, Himeji-shi (JP)

(21) Appl. No.: 15/811,058

(22) Filed: Nov. 13, 2017

(30) Foreign Application Priority Data
Nov. 14, 2016 (JP) 2016-221668

(51) Int. Cl. G07D 11/00; B65H 29/50

(52) U.S. Cl. CPC G07D 11/0027; G07D 11/0033; G07D 11/0066; B65H 2404/63; B65H 29/50; G07D 11/0018; G07D 11/0006

(57) ABSTRACT

Disclosed is a paper sheet storage cassette (for example, banknote collection cassette 42) that includes: a stacking unit (for example, ascending/descending stage 46) in which paper sheets (for example, banknotes) inserted into the paper sheet storage cassette from the outside are stacked in a layered state; a stacking wheel 44 configured to send paper sheets inserted into the paper sheet storage cassette from the outside, one by one, to the stacking unit; a paper sheet passing space (for example, banknote passing space 48) through which the paper sheets to be sent into the stacking unit by the stacking wheel 44 pass; and an inhibiting portion 50 configured to inhibit the paper sheets stacked in the stacking unit from being moved toward the paper sheet passing space.

### CROSS-REFERENCE TO RELATED APPLICATION

This application claims priority to Japanese Patent Application No. 2016-221668 filed on Nov. 14, 2016, the entire contents of which are incorporated herein by reference.

### BACKGROUND OF THE INVENTION

### 1. Field of the Invention

The present invention relates to a paper sheet storage cassette which is portable and in which paper sheets such as banknotes are stacked in a layered state, and a paper sheet handling machine to which the paper sheet storage cassette is detachably mounted.

### 2. Description of the Related Art

To date, various types of paper sheet storage cassettes have been known as paper sheet storage cassettes which is portable and in which paper sheets such as banknotes are stacked in a layered state. For example, Japanese Patent No. 5363531 (JP5363531B) discloses a technique in which a spiral stacking wheel is provided near an inlet in a paper sheet storage cassette, and paper sheets inserted through the inlet into the paper sheet storage cassette from the outside are each stored between blades of the stacking wheel, and thereafter stacked onto an ascending/descending stage from the stacking wheel, to stack the paper sheets on the ascending/descending stage in an aligned state. In such a paper sheet storage cassette, in a case where a paper sheet is inserted along the its long edge through the inlet into the paper sheet storage cassette from the outside, a region (so-called paper sheet passing region) through which a paper sheet stored between the blades of the stacking wheel passes when the paper sheet is sent onto the ascending/descending stage by the stacking wheel, needs to be formed near the stacking wheel. More specifically, such a paper sheet passing region is formed between the stacking wheel and an inner wall on a side facing the inlet, among inner walls of the paper sheet storage cassette. Unless such a paper sheet passing region is formed near the stacking wheel in the paper sheet storage cassette, when a paper sheet is sent onto the ascending/descending stage by the stacking wheel, the paper sheet stored between the blades of the stacking wheel collides with the inner wall of the paper sheet storage cassette, and the paper sheet is thus greatly curved, so that paper sheets cannot be stacked on the ascending/descending stage in an aligned state. Furthermore, also in a paper sheet storage cassette in which a paper sheet is inserted along its short edge through an inlet into the paper sheet storage cassette from the outside, a problem arises that, when the paper sheet storage cassette is transported, the end edge, on the short edge side, of a paper sheet stacked on an ascending/descending stage is moved so as to be distant from the ascending/descending stage, and the paper sheets stacked on the ascending/descending stage in a layered state may become misaligned.

### SUMMARY OF THE INVENTION

In a case where the paper sheet passing region is thus formed in the paper sheet storage cassette, a problem arises that, when the paper sheet storage cassette is transported, a paper sheet stacked on the ascending/descending stage is moved toward the upper portion of the paper sheet passing region (that is, moved so as to be distant from the ascending/descending stage), and the paper sheets stacked on the ascending/descending stage in a layered state may become greatly misaligned.

The present invention is made in view of such a problem, and an object of the present invention is to provide a paper sheet storage cassette which can prevent paper sheets stacked on a stacking unit in a layered state from becoming greatly misaligned when transported, and a paper sheet handling machine to which the paper sheet storage cassette is detachably mounted.

A paper sheet storage cassette of the present invention is portable and includes: an inlet, provided in the paper sheet storage cassette, through which a paper sheet is inserted into the paper sheet storage cassette from the outside; a stacking unit, provided inside the paper sheet storage cassette, on which paper sheets inserted through the inlet into the paper sheet storage cassette from the outside are stacked in a layered state, the stacking unit configured to move along a direction in which the paper sheets are stacked; and a stacking wheel configured to send paper sheets inserted through the inlet into the paper sheet storage cassette from the outside, one by one, to the stacking unit, the stacking wheel including a base body that rotates about a shaft, and a plurality of blades which extend outward from an outer circumferential surface of the base body in a direction opposite to a direction of rotation of the base body, the stacking wheel configured to send paper sheets stored between the blades into the stacking unit, a paper sheet passing space through which paper sheets to be sent into the stacking unit by the stacking wheel pass, the paper sheet passing space being formed near the stacking wheel inside the paper sheet storage cassette; and an inhibiting portion configured to inhibit a paper sheet stacked on the stacking unit from being moved toward the paper sheet passing space.

In the paper sheet storage cassette of the present invention, the inhibiting portion may be provided in a portion facing the stacking wheel, of an inner wall of the paper sheet storage cassette.

In the paper sheet storage cassette of the present invention, the inhibiting portion may be provided in a portion, of the inner wall of the paper sheet storage cassette, which faces an edge, on a short edge side, of a paper sheet to be sent into the stacking unit by the stacking wheel.

In the paper sheet storage cassette of the present invention, the inhibiting portion may be disposed above a lower end of a blade passing region through which each blade of the stacking wheel passes.

In the paper sheet storage cassette of the present invention, the inhibiting portion may have one or more groove portions formed in the inner wall of the paper sheet storage cassette, and at least a part of each of the one or more groove portions may form a stepped shape by which an edge of a paper sheet can be caught when the paper sheet stacked in the stacking unit is moved toward the paper sheet passing space.

In this case, the one or more groove portions may be provided so as to be aligned along a direction in which paper sheets are stacked in the stacking unit.

Furthermore, the one or more groove portions may be each formed so as to be a straight line that extends almost parallel to a direction in which the shaft of the stacking wheel extends.

Furthermore, the one or more groove portions may each include a tilted surface that is tilted relative to a direction in which paper sheets are stacked in the stacking unit.

In the paper sheet storage cassette of the present invention, the inhibiting portion may have a projection that is disposed on the inner wall of the paper sheet storage cassette, and that projects from the inner wall toward the paper sheet passing space, and at least a part of the projection may form a stepped shape by which an edge of a paper sheet can be caught when the paper sheet stacked on the stacking unit is moved toward the paper sheet passing space.

In this case, a plurality of the projections may be provided so as to be aligned along a direction in which paper sheets are stacked in the stacking unit.

In the paper sheet storage cassette of the present invention, the inhibiting portion may have a guide member that is movable between an advanced position at which the guide member advances to the paper sheet passing space and a retracted position at which the guide member retracts from the paper sheet passing space, and the guide member may inhibit a paper sheet stacked in the stacking unit from being moved toward the paper sheet passing space when the guide member is positioned at the advanced position.

In the paper sheet storage cassette of the present invention, the inhibiting portion may comprise a frictional material that causes a friction force such that, when a paper sheet stacked in the stacking unit is moved toward the paper sheet passing space, the friction force caused between the paper sheet and the frictional material is higher than a friction force caused between the paper sheet and a material of the inner wall of the paper sheet storage cassette.

In the paper sheet storage cassette of the present invention, the inhibiting portion may have a pressing member that presses paper sheets stacked in the stacking unit in a layered state toward the stacking unit.

In this case, the pressing member may comprise a frictional material that causes a friction force such that a friction force caused between the frictional material and one or more paper sheets stacked in the stacking unit and pressed by the pressing member is higher than a friction force caused between a material of the inner wall of the paper sheet storage cassette, and the one or more paper sheets pressed by the pressing member.

In the paper sheet storage cassette of the present invention, paper sheets stacked in the stacking unit in a layered state may be pressed by the stacking unit toward the stacking wheel when the paper sheet storage cassette is transported.

A paper sheet handling machine of the present invention is a paper sheet handling machine to which the paper sheet storage cassette as described above is detachably mounted, and a paper sheet is transported through the inlet of the paper sheet storage cassette from the paper sheet handling machine into the paper sheet storage cassette.

### BRIEF DESCRIPTION OF THE DRAWINGS

FIG. 1 is a perspective view of an outer appearance of a money handling system according to an embodiment of the present invention;

FIG. 2 is a side view of an internal structure of a banknote handling machine in the money handling system shown in FIG. 1;

FIG. 3 is a side view of an internal structure of a banknote collection cassette provided in a collection unit in the money handling system shown in FIG. 1;

FIG. 4 is a side view illustrating a state where a lot of banknotes are stored inside the banknote collection cassette shown in FIG. 3;

FIG. 5 is a side cross-sectional view illustrating a state where banknotes stored in the banknote collection cassette shown in FIG. 3 are caught by a groove portion of an inhibiting portion;

FIG. 6 is a side cross-sectional view illustrating a state where banknotes stored in a banknote collection cassette of conventional art are moved toward a banknote passing space;

FIG. 7 is a side cross-sectional view of another exemplary structure of a groove portion of an inhibiting portion in a banknote collection cassette provided in the collection unit of the money handling system according to an embodiment of the present invention;

FIG. 8 is a side cross-sectional view of still another exemplary structure of a groove portion of an inhibiting portion in a banknote collection cassette provided in the collection unit of the money handling system according to an embodiment of the present invention;

FIG. 9 is a side cross-sectional view of another example of an inhibiting portion of a banknote collection cassette provided in the collection unit of the money handling system according to an embodiment of the present invention;

FIG. 10 is a side cross-sectional view of still another example of an inhibiting portion of a banknote collection cassette provided in the collection unit of the money handling system according to an embodiment of the present invention;

FIG. 11 is a side cross-sectional view of still another example of an inhibiting portion of a banknote collection cassette provided in the collection unit of the money handling system according to an embodiment of the present invention;

FIG. 12 is a side cross-sectional view of an internal structure of a banknote collection cassette according to modification; and

FIG. 13 is a side cross-sectional view illustrating a state where banknotes each having a long banknote length and banknotes each having a short banknote length are alternately stacked on an ascending/descending stage in the banknote collection cassette shown in FIG. 3.

### DESCRIPTION OF THE PREFERRED EMBODIMENTS

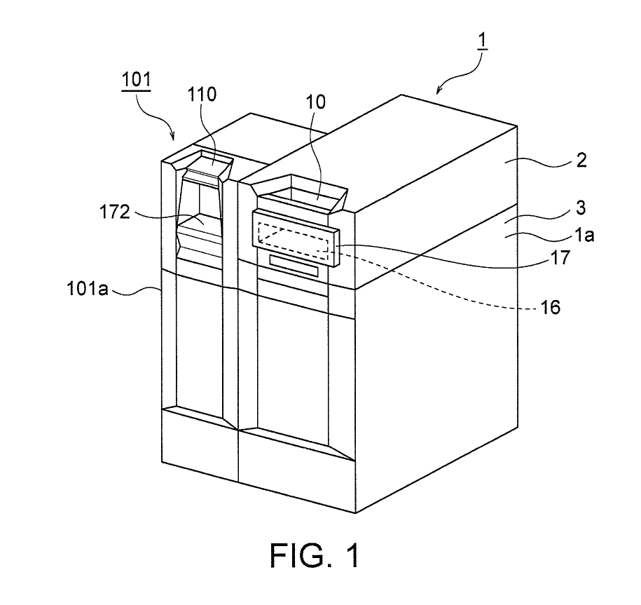

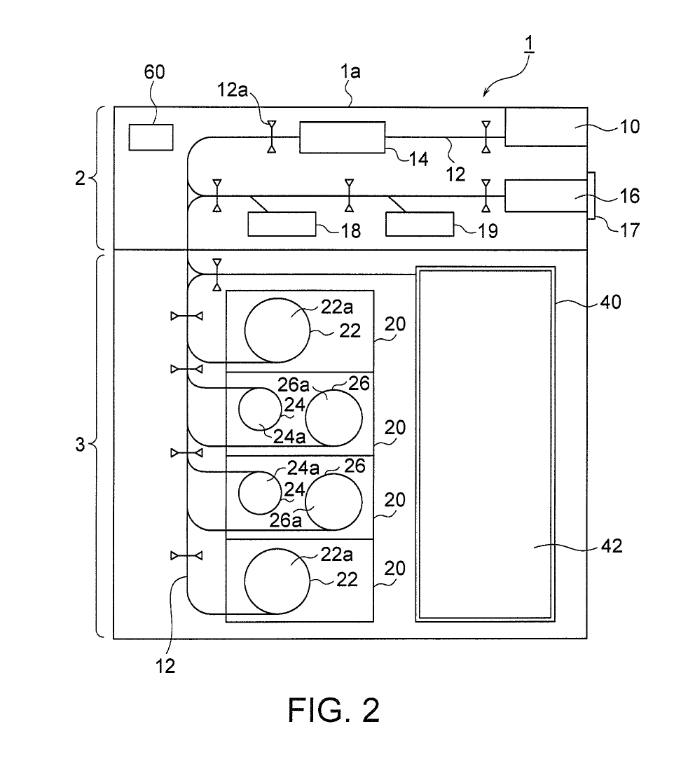

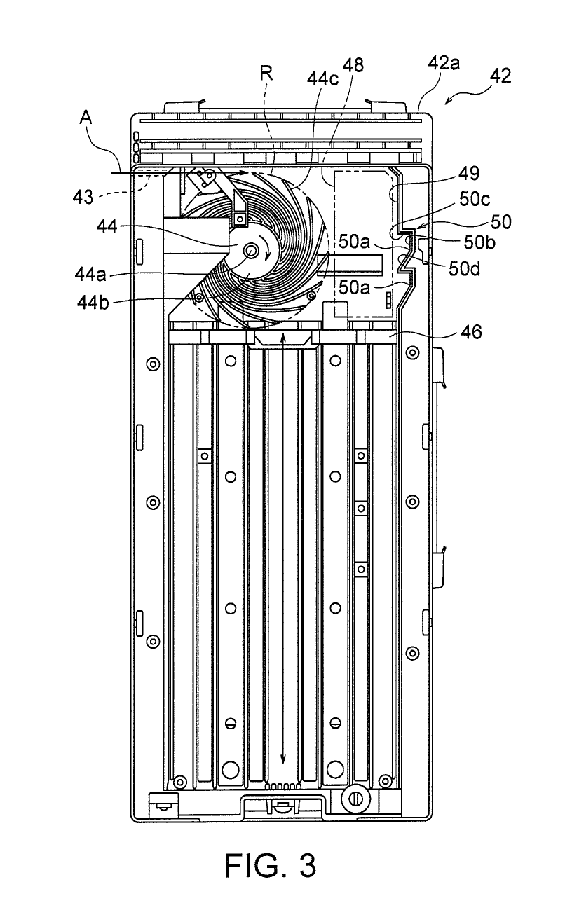

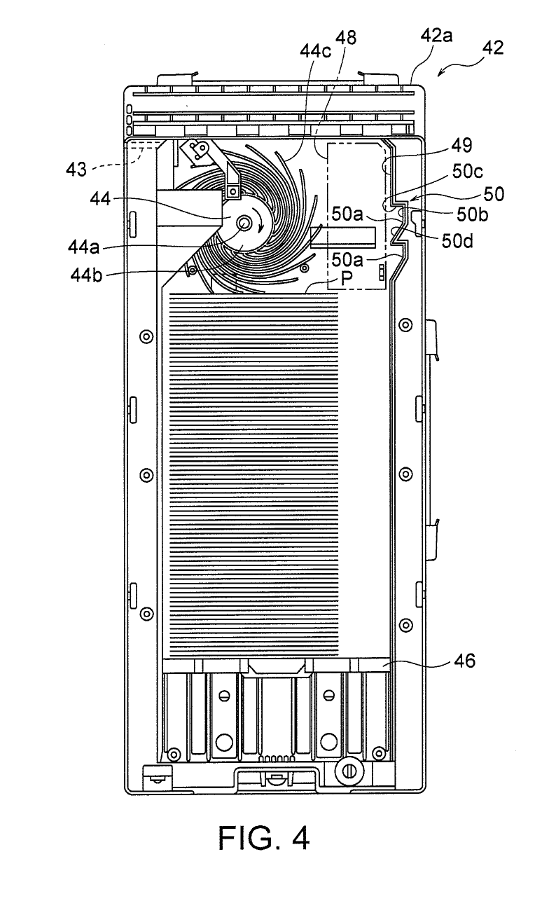

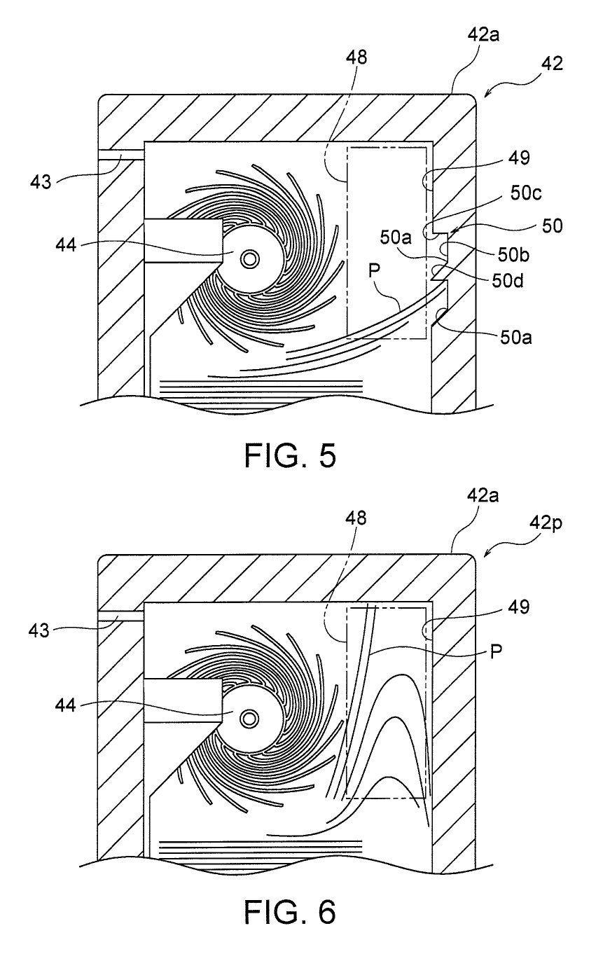

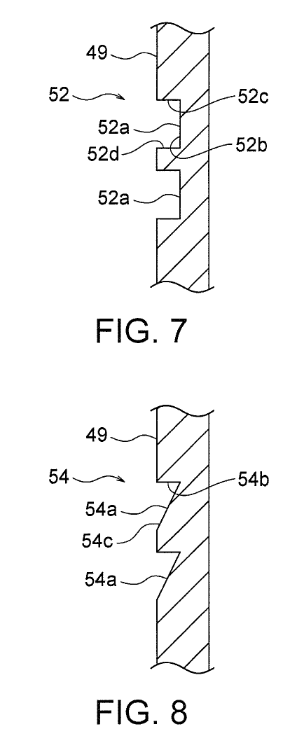

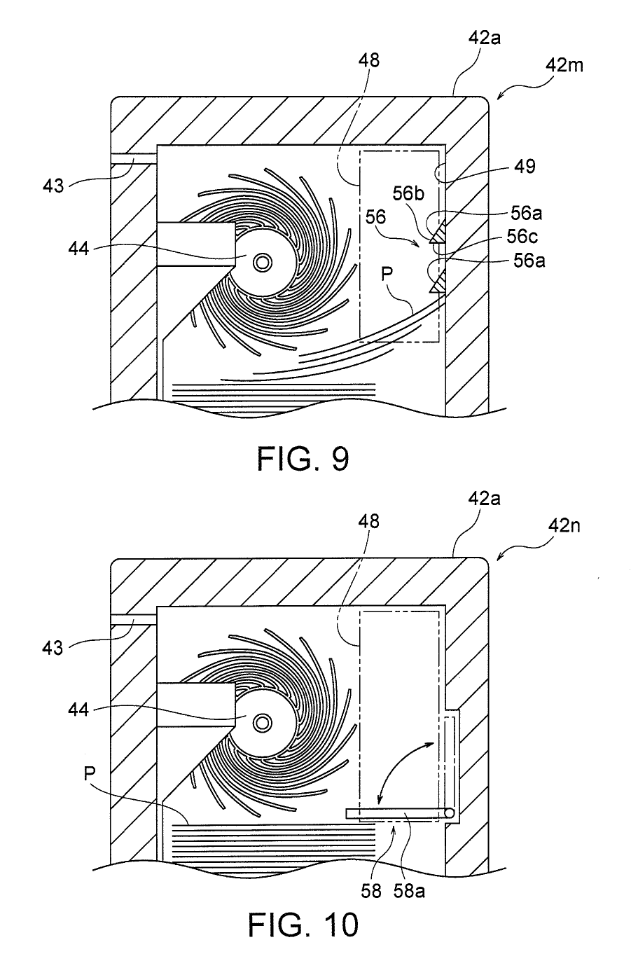

Hereinafter, embodiments of the present invention will be described with reference to the drawings. FIG. 1 to FIG. 11 illustrate a money handling system according to the present embodiment. Among them, FIG. 1 is a perspective view of an outer appearance of the money handling system according to the present embodiment, and FIG. 2 is a side view of an internal structure of a banknote handling machine in the money handling system shown in FIG. 1. Furthermore, FIG. 3 is a side view of an internal structure of a banknote collection cassette provided in a collection unit in the money handling system shown in FIG. 1, FIG. 4 is a side view illustrating a state where a lot of banknotes are stored in the banknote collection cassette shown in FIG. 3, and FIG. 5 is a side cross-sectional view illustrating a state where banknotes stored in the banknote collection cassette shown in FIG. 3 are caught by a groove portion of an inhibiting portion. FIG. 6 is a side cross-sectional view illustrating a state where banknotes stored in a banknote collection cassette of conventional art are moved toward a banknote passing space. Furthermore, FIG. 7 and FIG. 8 are side cross-sectional views of other various exemplary structures of groove portions of inhibiting portions in banknote collection cassettes provided in the collection units of the money handling system according to the present embodiment, and FIG. 9 to FIG. 11 are side cross-sectional views of other various examples of inhibiting portions of banknote collection cassettes provided in the collection units of the money handling system according to the present embodiment. In FIG. 4 to FIG. 6 and FIG. 9 to FIG. 11, banknotes stored in the banknote collection cassette are each represented by a reference character P.

The money handling system according to the present embodiment is disposed in stores such as supermarkets and convenience stores, and performs depositing of banknotes and coins as sales proceeds and dispensing of banknotes and coins as changes. As shown in FIG. 1, the money handling system according to the present embodiment includes a banknote handling machine 1 and a coin handling machine 101 that are aligned in the left-right direction. Furthermore, a POS register (not shown) is connected to the banknote handling machine 1 by means of a LAN or the like such that the POS register and the banknote handling machine 1 can communicate with each other. Furthermore, a settlement counter (table or counter) that partitions a clerk and a customer from each other is disposed in a settlement place in the store, and the clerk waits on one side of the settlement counter. The POS register is disposed, in many cases, on the side on which a clerk waits so as to allow the clerk to operate the POS register. Meanwhile, a customer stands on the other side of the settlement counter, and places, on the settlement counter, commodities to be purchased. The clerk registers, in the POS register, the commodity numbers and prices of the commodities placed on the settlement counter. Furthermore, the clerk receives money from the customer, and inserts the money into the money handling system. Such a money handling system will be described below in detail.

Firstly, a structure of the banknote handling machine 1 will be described in detail with reference to FIG. 2. The right side surface of a housing 1a (described below) in FIG. 2 corresponds to the front side surface of the banknote handling machine 1 (that is, the front side surface of the banknote handling machine 1 as viewed from the front side thereof as shown in FIG. 1), and the leftward direction in FIG. 2 is a depth direction of the housing 1a.

As shown in FIG. 2, the banknote handling machine 1 has the housing 1a that is almost rectangular-parallelepiped-shaped. Furthermore, the banknote handling machine 1 has an upper assembly 2 and a lower assembly 3. The upper assembly 2 includes: a banknote inlet unit 10 through which a banknote is inserted into the housing 1a from the outside; a transport unit 12 that transports the banknote inserted into the housing 1a through the banknote inlet unit 10; a recognition unit 14 that is disposed in the transport unit 12 and recognizes the banknote transported by the transport unit 12; and a banknote outlet unit 16 through which the banknote is discharged from the inside of the housing 1a to the outside.

The banknote inlet unit 10 includes a plurality of rollers such as feed rollers and kicker rollers, and banknotes which are placed in the banknote inlet unit 10 in a layered state by an operator are kicked from the lowermost banknote, one by one, by the kicker rollers toward the feed rollers, and the kicked banknotes are fed one by one into the housing 1a by the feed rollers. The banknotes fed into the housing 1a by the banknote inlet unit 10 are transported one by one by the transport unit 12. In the present embodiment, the banknotes are fed along the long edge of each banknote from the banknote inlet unit 10 into the transport unit 12, and the banknotes are transported along the long edge of each banknote in the transport unit 12. Furthermore, the recognition unit 14 performs recognition of a denomination, authenticity, fitness/unfitness, old/new version, face/back, transport state, and the like of each banknote transported by the transport unit 12. The banknotes recognized by the recognition unit 14 are transported by the transport unit 12 into storage/feeding units 20 described below according to, for example, each denomination.

In diverging portions of the transport unit 12, diverting members (not shown) such as diverters, respectively, are provided, and a destination to which the banknote is transported is determined in the diverging portion by means of the diverting member. Furthermore, as shown in FIG. 2, banknote detection sensors 12a for detecting each banknote transported by the transport unit 12 are provided in various portions of the transport unit 12. Each banknote detection sensor 12a includes, for example, an optical sensor that has a light emitting element and a light receiving element. When light emitted from the light emitting element is blocked by a banknote transported by the transport unit 12 and is not received by the light receiving element, the banknote is detected by the banknote detection sensor 12a. Detection information of the banknote detected by each banknote detection sensor 12a is transmitted to a control unit 60 described below. Furthermore, the control unit 60 determines whether or not a distance between a plurality of banknotes transported by the transport unit 12 is a predetermined distance, on the basis of the detection results for the banknotes detected by the banknote detection sensors 12a. In a case where the control unit 60 determines that the distance between the plurality of banknotes transported by the transport unit 12 is greatly different from the predetermined distance, occurrence of abnormality in transporting such as skew, overlapping, or chaining is detected for a banknote transported by the transport unit 12.

Further, in the upper assembly 2, two banknote storage units 18, 19 (capture bins) are connected to the transport unit 12. Each of the banknote storage units 18, 19 stores banknotes transported by the transport unit 12. However, banknotes stored in the banknote storage units 18, 19 cannot be fed from the banknote storage units 18, 19 into the transport unit 12. Furthermore, the banknote storage units 18, 19 are positioned such that banknotes can be transported into the banknote storage units 18, 19 from the transport unit 12 in both banknote depositing and banknote dispensing. Furthermore, in the present embodiment, in one of the two banknote storage units 18, 19 (for example, the banknote storage unit 19 closer to the banknote outlet unit 16), at least one of a counterfeit note and a suspect note is stored. Furthermore, in the other of the banknote storage units (for example, the banknote storage unit 18 that is farther from the banknote outlet unit 16), banknotes (specifically, for example, banknotes that are abnormally transported) that are fed from the storage/feeding units 20 described below into the transport unit 12 but cannot be discharged to the outside of the housing 1a by the banknote outlet unit 16 when banknote dispensing is performed, are stored.

Furthermore, as shown in FIG. 2, the transport unit 12 is provided so as to extend over both the upper assembly 2 and the lower assembly 3, and a plurality (four in the example shown in FIG. 2) of the storage/feeding units 20 are connected to the transport unit 12 in the lower assembly 3. The storage/feeding units 20 are aligned in parallel with each other along the height direction of the banknote handling machine 1. Furthermore, each storage/feeding unit 20 stores banknotes transported from the transport unit 12, and can feed the stored banknotes one by one into the transport unit 12. More specifically, the uppermost storage/feeding unit 20 and the lowermost storage/feeding unit 20, among the four storage/feeding units 20, have banknote storing mechanisms 22, respectively, each having one drum 22a, and the banknotes transported by the transport unit 12 are each sandwiched between paired tapes one by one and the tapes are wound onto the drum 22a together with the sandwiched banknote. Furthermore, when the drum 22a rotates in a direction opposite to the tape winding direction, the tapes are unwound from the drum 22a and the banknotes each sandwiched between the paired tapes are fed one by one into the transport unit 12. Furthermore, each of the second storage/feeding unit 20 and the third storage/feeding unit 20, among the four storage/feeding units 20, which are counted from the uppermost one, includes two banknote storing mechanisms 24 and 26 having different maximum banknote storage capacities, respectively, and the banknote storing mechanisms 24 and 26 have drums 24a and 26a, respectively. Specifically, in the banknote storing mechanism 24, 26, the banknotes transported from the transport unit 12 are each sandwiched between paired tapes one by one, and the tapes are wound onto the drum 24a, 26a together with the sandwiched banknote. Furthermore, when the drum 24a, 26a rotates in a direction opposite to the tape winding direction, the tapes are unwound from the drum 24a, 26a, and the banknotes each sandwiched between the paired tapes are fed one by one into the transport unit 12. The length of the tape that is wound onto the drum 26a is greater than the length of the tape that is wound onto the drum 24a. Thus, the maximum storage number of banknotes in the drum 26a is greater than the maximum storage number of banknotes in the drum 24a. Specifically, the maximum storage number of banknotes in the banknote storing mechanism 24 is, for example, 100, whereas the maximum storage number of banknotes in the banknote storing mechanism 26 is 200.

Furthermore, in the lower assembly 3, a collection unit 40 is provided in the transport unit 12, and the collection unit 40 is used when banknotes stored in the storage/feeding units 20 are collected. More specifically, a banknote collection cassette 42 that stores banknotes in a layered state is detachably mounted to the collection unit 40, and banknotes transported from the storage/feeding units 20 through the transport unit 12 into the collection unit 40 are stored in the banknote collection cassette 42. Furthermore, banknotes of denominations that are not assigned to the storage/feeding units 20, and overflow banknotes that cannot be stored in the storage/feeding unit 20 for the corresponding denomination since the storage/feeding unit 20 therefor is full, are also stored in the banknote collection cassette 42 mounted to the collection unit 40. The banknotes are collected together with the banknote collection cassette 42 from the banknote handling machine 1 by the banknote collection cassette 42 being taken out from the collection unit 40. The structure of the banknote collection cassette 42 will be described below in detail.

Furthermore, in the banknote handling machine 1 according to the present embodiment, the lower assembly 3 is structured as a safe housing the inside of which is accessible only by an operator who has a predetermined access right. More specifically, a security transport company is authorized to manage the banknotes stored in the storage/feeding units 20 and the collection unit 40 inside the lower assembly 3, and only a guard of the security transport company is allowed to open a door (not shown) of the lower assembly 3 and access the inside of the lower assembly 3. Specifically, a locking mechanism (not shown) for locking the door of the lower assembly 3 in a closed state is provided, and a key and a PIN number for unlocking the door locked by the locking mechanism are provided only to an operator (for example, a guard of a security transport company) who is allowed to access the inside of the lower assembly 3. Thus, the banknote collection cassette 42 mounted to the collection unit 40 can be collected from the inside of the lower assembly 3, only by the guard of the security transport company. That is, the clerks of the store and the like are not allowed to access the inside of the lower assembly 3 and take out banknotes stored in the storage/feeding units 20 and the collection unit 40. Thus, the security for preventing banknotes stored in the storage/feeding units 20 and the collection unit 40 from being stolen, can be enhanced.

As shown in FIG. 1 and FIG. 2, the banknote outlet unit 16 has a shutter mechanism 17 that opens and closes the outlet for banknotes in the banknote outlet unit 16. As shown in FIG. 1 and FIG. 2, in a case where the outlet for banknotes in the banknote outlet unit 16 is closed by the shutter mechanism 17, an operator is not allowed to take out banknotes that are transported from the transport unit 12 into the banknote outlet unit 16, from the banknote outlet unit 16, to the outside of the housing 1a, when banknote dispensing is performed. Meanwhile, in a case where the outlet for the banknotes in the banknote outlet unit 16 is opened by the shutter mechanism 17, an operator is allowed to take out banknotes transported from the transport unit 12 into the banknote outlet unit 16, from the banknote outlet unit 16, to the outside of the housing 1a. When the banknote handling machine 1 is in a stand-by state, the outlet for banknotes in the banknote outlet unit 16 is closed by the shutter mechanism 17.

Next, a structure of the coin handling machine 101 will be briefly described in detail. The coin handling machine 101 includes: a housing 101a that is almost rectangular-parallelepiped-shaped; a coin inlet unit 110 through which coins are inserted into the housing 101a from the outside; and a coin outlet unit 172 through which coins are discharged from the inside of the housing 101a to the outside. Furthermore, inside the housing 101a, a recognition unit (not shown) that recognizes coins inserted into the housing 101a by the coin inlet unit 110, and a plurality of storage/feeding units (not shown) in which coins recognized by the recognition unit are stored for each denomination, are disposed. Coins fed from the storage/feeding units are discharged from the inside of the housing 101a to the outside by the coin outlet unit 172. Furthermore, inside the housing 101a, a collection box (not shown) used as an overflow coin storage unit is disposed. The collection box can be horizontally extracted toward the front side from a collection box storage unit (not shown) provided in the lower portion of the housing 101a. In such a collection box, overflow coins that cannot be stored in the storage/feeding units, and coins that are fed from the storage/feeding units and are to be collected, are stored. After the coins are stored in the collection box, when a guard of a security transport company or the like extracts the collection box toward the front side from the collection box storage unit, the guard or the like is allowed to collect the coins together with the collection box.

Next, a structure of a control system of the banknote handling machine 1 according to the present embodiment will be briefly described. As shown in FIG. 2, inside the housing 1a of the banknote handling machine 1, the control unit 60 is provided, and the control unit 60 controls the components of the banknote handling machine 1. More specifically, to the control unit 60, the banknote inlet unit 10, the transport unit 12, the banknote detection sensors 12a, the recognition unit 14, the shutter mechanism 17, the storage/feeding units 20, and the like are connected. Signals based on results of banknote recognition by the recognition unit 14, and signals based on results of banknote detection by the banknote detection sensors 12a are transmitted to the control unit 60. Furthermore, the control unit 60 transmits instruction signals to the components such as the banknote inlet unit 10, the transport unit 12, the shutter mechanism 17, and the storage/feeding units 20 to control the components. Furthermore, an operation/display unit (not shown) such as a touch panel is provided on the front surface or the upper surface of the housing 1a of the banknote handling machine 1, and the operation/display unit is also connected to the control unit 60. On such an operation/display unit, for example, information representing: handling state of banknotes and coins in the banknote handling machine 1 and the coin handling machine 101; inventory amounts, for each denomination, of banknotes and coins stored in each storage/feeding unit 20 of the banknote handling machine 1 and each storage/feeding unit of the coin handling machine 101; or the like, is displayed. Furthermore, an operator is allowed to input various instructions to the control unit 60 through the operation/display unit.

Next, a structure of the banknote collection cassette 42 that is detachably mounted to the collection unit 40 will be described in detail with reference to FIG. 3 to FIG. 5. As shown in FIG. 3 and the like, the banknote collection cassette 42 according to the present embodiment includes: a casing 42a that is almost rectangular-parallelepiped-shaped; and an inlet 43 through which banknotes are inserted into the casing 42a from the outside. The inlet 43 is formed in the upper portion of the side surface of the casing 42a. When the banknote collection cassette 42 is mounted to the collection unit 40, banknotes transported from the transport unit 12 into the collection unit 40 are inserted through the inlet 43 into the casing 42a of the banknote collection cassette 42. In the present embodiment, banknotes are transported along their long edges in the transport unit 12, and the banknotes are transported into the casing 42a along their long edges through the inlet 43 of the banknote collection cassette 42. Furthermore, inside the casing 42a, an ascending/descending stage 46 (stacking unit), on which banknotes inserted through the inlet 43 into the casing 42a from the outside are stacked in a layered state, is provided, and the ascending/descending stage 46 moves along the banknote stacking direction (that is, the up-down direction in FIG. 3). More specifically, each time a banknote is stacked on the ascending/descending stage 46, the ascending/descending stage 46 descends over a short distance. Thus, a space in which banknotes are stacked is formed between a stacking wheel 44 described below, and the ascending/descending stage 46.

Furthermore, as shown in FIG. 3, in an upper region inside the casing 42a, the stacking wheel 44 for sending banknotes that are inserted through the inlet 43 into the casing 42a from the outside, one by one, onto the ascending/descending stage 46 is provided. More specifically, the stacking wheel 44 rotates about a shaft 44a that is orthogonal to the sheet surface of FIG. 3, in the clockwise direction shown in FIG. 3. Furthermore, as shown in FIG. 4, the stacking wheel 44 includes: a base body 44b that rotates about the shaft 44a; and a plurality of blades 44c that extend outward from the outer circumferential surface of the base body 44b in a direction (that is, in the counterclockwise direction in FIG. 3) opposite to a direction of rotation of the base body 44b. The blades 44c are equally spaced from each other on the outer circumferential surface of the base body 44b. While the banknote handling machine 1 operates, the stacking wheel 44 is rotated about the shaft 44a in the clockwise direction shown in FIG. 3, by a driving force transmitted from the main body of the banknote handling machine 1 to the banknote collection cassette 42. Banknotes are transported one by one to the stacking wheel 44 from the inlet 43. The stacking wheel 44 receives, between the two blades 44c, a banknote transported from the inlet 43, and sends, to the ascending/descending stage 46, the banknote received between the blades 44c. At this time, the end portion of the banknote received between the blades 44c of the stacking wheel 44 passes through a banknote passing space 48 (described below) formed lateral to the stacking wheel 44. More specifically, as described above, since a banknote is transported along its long edge through the inlet 43 of the banknote collection cassette 42 into the casing 42a, the edge, on one of the short edge sides, of the banknote received between the blades 44c of the stacking wheel 44 deeply enters between the blades 44c, and a portion, of the same banknote, near the edge on the other of the short edge sides passes through the banknote passing space 48. The stacking wheel 44 thus allows banknotes to be stacked on the ascending/descending stage 46 in an aligned state.

As shown in FIG. 3, the banknote passing space 48 through which a banknote sent onto the ascending/descending stage 46 by the stacking wheel 44 passes is formed between the stacking wheel 44 and an inner wall 49 that is among inner walls positioned lateral to the internal space of the casing 42a and that faces an inner wall in which the inlet 43 is formed. This is because, unless the banknote passing space 48 is formed near the stacking wheel 44 inside the banknote collection cassette 42, when the banknote is sent onto the ascending/descending stage 46 by the stacking wheel 44, the banknote stored between the blades 44c of the stacking wheel 44 collides with the inner wall 49, so that the banknote is greatly curved, and banknotes cannot be stacked on the ascending/descending stage 46 in an aligned state. Furthermore, in the present embodiment, an inhibiting portion 50 that inhibits a banknote stacked on the ascending/descending stage 46 from being moved toward the upper portion of the banknote passing space 48 when the banknote collection cassette 42 is taken out from the banknote handling machine 1 and the banknote collection cassette 42 is transported, is provided near the banknote passing space 48.

The inhibiting portion 50 is provided in a portion, facing the stacking wheel 44, of the inner wall 49 which is among the inner walls of the casing 42a and which faces the inner wall in which the inlet 43 is provided. More specifically, the inhibiting portion 50 has a plurality (specifically, for example, two) of groove portions 50a that are aligned along a direction (specifically, the up-down direction in FIG. 3) in which the banknotes are stacked on the ascending/descending stage 46. Furthermore, at least a part of each groove portion 50a forms a stepped shape by which the edge of a banknote can be caught when the banknote stacked on the ascending/descending stage 46 is moved toward the banknote passing space 48. More specifically, each groove portion 50a has: a straight line portion 50b that extends along a direction in which banknotes are stacked on the ascending/descending stage 46; a catching portion 50c that laterally extends from the upper end of the straight line portion 50b; and a tilted surface 50d that extends diagonally downward from the lower end of the straight line portion 50b. Furthermore, each groove portion 50a is formed so as to be a straight line that extends almost parallel to a direction (that is, direction orthogonal to the sheet surface of FIG. 3) in which the shaft 44a of the stacking wheel 44 extends. Specifically, each groove portion 50a extends over the entire length, of an internal region of the casing 42a, in a direction in which the shaft 44a of the stacking wheel 44 extends. Each of the groove portions 50a is structured such that, since the tilted surface 50d is tilted relative to a direction in which banknotes are stacked on the ascending/descending stage 46, when the banknote transported from the inlet 43 is received between the two blades 44c and the banknote received between the blades 44c is sent onto the ascending/descending stage 46, even if the edge, on the short edge side, of the banknote received between the two blades 44c hits against the inner wall 49 of the casing 42a, the edge portion of the banknote is sent along the tilted surface 50d onto the ascending/descending stage 46, so that the banknote can be prevented from being caught by each groove portion 50a.

The inhibiting portion 50 having the plurality (specifically, for example, two) of groove portions 50a is provided in a portion, of the inner wall 49 of the casing 42a, which faces the edge, on the short edge side, of a banknote sent onto the ascending/descending stage 46 by the stacking wheel 44. Furthermore, the inhibiting portion 50 is disposed above the lower end of a blade passing region (represented by a reference character R in FIG. 3) through which each blade 44c of the stacking wheel 44 passes.

The inhibiting portion 50 is thus provided in the inner wall 49 of the casing 42a. Therefore, when the banknote collection cassette 42 is taken out from the banknote handling machine 1 and the banknote collection cassette 42 is transported, a banknote stacked on the ascending/descending stage 46 is inhibited from being moved toward the upper portion of the banknote passing space 48. This will be described with reference to FIG. 4 and FIG. 5.

In a case where the banknote collection cassette 42 is taken out from the banknote handling machine 1 and the banknote collection cassette 42 is transported, the ascending/descending stage 46 is moved upward to press the banknotes stacked on the ascending/descending stage 46 in a layered state toward the stacking wheel 44 (see FIG. 4). Thus, when the banknote collection cassette 42 is transported, a plurality of banknotes in the layered state are sandwiched and pressed between the stacking wheel 44 and the ascending/descending stage 46, whereby the banknotes stacked on the ascending/descending stage 46 can be inhibited from becoming misaligned and being stacked in the misaligned state. However, even if the plurality of banknotes in the layered state are thus sandwiched and pressed between the stacking wheel 44 and the ascending/descending stage 46, the banknotes (in particular, one or more of the banknotes on the stacking wheel 44 side) stacked on the ascending/descending stage 46 are misaligned and stacked in the misaligned state in some cases. Meanwhile, in the present embodiment, since the inhibiting portion 50 is provided in the inner wall 49 of the casing 42a, even if banknotes stacked on the ascending/descending stage 46 are misaligned and one or more of the banknotes on the stacking wheel 44 side are moved toward the banknote passing space 48, the edge of the banknote can be caught by the groove portions 50a (more specifically, the catching portion 50c of each groove portion 50a) of the inhibiting portion 50 as shown in FIG. 5, whereby the banknote can be inhibited from being moved to the upper portion of the banknote passing space 48.

For comparison, a banknote collection cassette 42p, of conventional art, in which the inhibiting portion 50 is not provided in the inner wall 49 will be described with reference to FIG. 6. The banknote collection cassette 42p as shown in FIG. 6 is such that, in a case where the banknote collection cassette 42p is taken out from the banknote handling machine 1 and the banknote collection cassette 42p is transported, if the banknotes stacked on the ascending/descending stage 46 are misaligned and one or more of the banknotes on the stacking wheel 44 side are moved toward the banknote passing space 48, the banknotes are moved to the upper portion of the banknote passing space 48, whereby the banknotes in the casing 42a are greatly misaligned. Meanwhile, in the banknote collection cassette 42 according to the present embodiment, the edge of the banknote can be caught by the groove portion 50a of the inhibiting portion 50, whereby the banknote can be inhibited from being moved to the upper portion of the banknote passing space 48, and the banknotes inside the casing 42a can be thus prevented from being greatly misaligned.

The inhibiting portion that inhibits a banknote stacked on the ascending/descending stage 46 from being moved toward the banknote passing space 48 is not limited to one having the structure shown in FIG. 3 to FIG. 5. As an inhibiting portion that inhibits a banknote stacked on the ascending/descending stage 46 from being moved toward the banknote passing space 48, groove portions having structures shown in FIG. 7 and FIG. 8 may be used. In an inhibiting portion 52 shown in FIG. 7, groove portions 52a do not have tilted surfaces that extend diagonally downward from the lower ends of the straight line portions extending along a direction in which banknotes are stacked on the ascending/descending stage 46, and each of the groove portions 52a has other straight line portions 52c, 52d that laterally extend from the upper end and the lower end, respectively, of a straight line portion 52b extending in the up-down direction. Furthermore, each of the groove portions 52a is formed so as to be a straight line that extends almost parallel to a direction in which the shaft 44a of the stacking wheel 44 extends. Specifically, each of the groove portions 52a extends over the entire length, of an internal region of the casing 42a, in a direction in which the shaft 44a of the stacking wheel 44 extends. Also in a case where the inhibiting portion 52 that has the groove portions 52a is thus provided in the inner wall 49 of the casing 42a, when the banknote collection cassette 42 is taken out from the banknote handling machine 1 and the banknote collection cassette 42 is transported, even if banknotes stacked on the ascending/descending stage 46 are misaligned and one or more of the banknotes on the stacking wheel 44 side are moved toward the banknote passing space 48, the edge of the banknote can be caught by the groove portion 52a of the inhibiting portion 52, whereby the banknote can be inhibited from being moved to the upper portion of the banknote passing space 48.

Furthermore, an inhibiting portion 54 shown in FIG. 8 is structured such that groove portions 54a do not have straight line portions that extend in a direction in which banknotes are stacked on the ascending/descending stage 46, and each of the groove portions 54a includes: a catching portion 54b that laterally extends; and a tilted surface 54c that extends diagonally downward from the end portion, on the depth side, of the catching portion 54b. Furthermore, each of the groove portions 54a is formed so as to be a straight line that extends almost parallel to a direction in which the shaft 44a of the stacking wheel 44 extends. Specifically, each of the groove portions 54a extends over the entire length, of an internal region of the casing 42a, in a direction in which the shaft 44a of the stacking wheel 44 extends. Also in a case where the inhibiting portion 54 that has the groove portions 54a is thus provided in the inner wall 49 of the casing 42a, when the banknote collection cassette 42 is taken out from the banknote handling machine 1 and the banknote collection cassette 42 is transported, even if banknotes stacked on the ascending/descending stage 46 are misaligned and one or more of the banknotes on the stacking wheel 44 side are moved toward the banknote passing space 48, the edge of the banknote can be caught by the groove portion 54a (specifically, catching portion 54b) of the inhibiting portion 54, whereby the banknote can be inhibited from being moved to the upper portion of the banknote passing space 48.

Furthermore, as an inhibiting portion that inhibits a banknote stacked on the ascending/descending stage 46 from being moved toward the banknote passing space 48, a projection that projects from the inner wall 49 toward the banknote passing space 48 may be used instead of the groove portion provided in the inner wall 49 of the casing 42a. A structure of the inhibiting portion having such a projection will be described with reference to FIG. 9.

A banknote collection cassette 42m according to modification shown in FIG. 9 is structured such that an inhibiting portion 56 that includes a plurality (specifically, two) of projections 56a projecting from the inner wall 49 toward the banknote passing space 48 is provided in the inner wall 49, among inner walls of the banknote collection cassette 42m, which faces the stacking wheel 44. The projections 56a are disposed so as to be aligned in a direction in which banknotes are stacked on the ascending/descending stage 46. Furthermore, each projection 56a forms a stepped shape by which the edge of a banknote can be caught when the banknote stacked on the ascending/descending stage 46 is moved toward the banknote passing space 48. Specifically, each projection 56a includes: a tilted surface 56b that is tilted relative to a direction in which banknotes are stacked on the ascending/descending stage 46; and a catching portion 56c that laterally extends. Since the tilted surface 56b is thus provided in each projection 56a, when the banknote sent from the inlet 43 is received between the two blades 44c and the banknote received between the blades 44c is sent onto the ascending/descending stage 46, the edge, on the short edge side, of the banknote received between the two blades 44c can be prevented from being caught by each projection 56a of the inhibiting portion 56. Furthermore, in the banknote collection cassette 42m according to modification shown in FIG. 9, in a case where the banknote collection cassette 42m is taken out from the banknote handling machine 1 and the banknote collection cassette 42m is transported, even if banknotes stacked on the ascending/descending stage 46 are misaligned and one or more of the banknotes on the stacking wheel 44 side are moved toward the banknote passing space 48, the edge of the banknote can be caught by the projection 56a (specifically, catching portion 56c) of the inhibiting portion 56, whereby the banknote can be inhibited from being moved to the upper portion of the banknote passing space 48. Each projection 56a of the inhibiting portion 56 may be formed so as to be a straight line that extends almost parallel to a direction in which the shaft 44a of the stacking wheel 44 extends. Alternatively, the width of each projection 56a in the direction in which the shaft 44a of the stacking wheel 44 extends, may be sufficiently small relative to the entire length of the internal region of the casing 42a.

Furthermore, as still another example of an inhibiting portion that inhibits a banknote stacked on the ascending/descending stage 46 from being moved toward the banknote passing space 48, an inhibiting portion having a guide member that is movable between an advanced position at which the guide member advances to the banknote passing space 48 and a retracted position at which the guide member retracts from the banknote passing space 48, may be used. A structure of the inhibiting portion having such a guide member will be described with reference to FIG. 10.

In a banknote collection cassette 42n according to another modification shown in FIG. 10, an inhibiting portion 58 has a guide member 58a that is movable between an advanced position (represented by a solid line in FIG. 10) at which the guide member 58a advances to the banknote passing space 48 and a retracted position (represented by an alternate long and short dash line in FIG. 10) at which the guide member 58a retracts from the banknote passing space 48. When the banknote collection cassette 42n is mounted to the collection unit 40, the guide member 58a is positioned at the retracted position. Thus, when a banknote transported from the inlet 43 is received between the two blades 44c and the banknote received between the blades 44c is sent onto the ascending/descending stage 46, the edge, on the short edge side, of the banknote received between the two blades 44c is not caught by the guide member 58a. Meanwhile, when the banknote collection cassette 42n is taken out from the collection unit 40, the guide member 58a is moved to the advanced position represented by the solid line in FIG. 10. When the guide member 58a is thus positioned at the advanced position, a banknote stacked on the ascending/descending stage 46 is inhibited from being moved toward the banknote passing space 48. In the banknote collection cassette 42n according to another modification as shown in FIG. 10, when the banknote collection cassette 42n is taken out from the banknote handling machine 1 and the banknote collection cassette 42n is transported, a banknote stacked on the ascending/descending stage 46 is inhibited, by the guide member 58a, from being moved toward the banknote passing space 48, whereby a state where the banknotes stacked on the ascending/descending stage 46 are misaligned and one or more of the banknotes on the stacking wheel 44 side are moved toward the upper portion of the banknote passing space 48, can be inhibited.

Furthermore, in the banknote collection cassettes 42, 42m, 42n described above, each of the inhibiting portions 50, 52, 54, 56, 58 may include a frictional material, such as rubber, which causes, when a banknote stacked on the ascending/descending stage 46 is moved toward the banknote passing space 48, a high friction force between the frictional material and the banknote. More specifically, a friction force caused between the banknote and the frictional material of the inhibiting portion 50, 52, 54, 56, 58 is higher than a friction force caused between the banknote and a material of the inner wall of the banknote collection cassette 42. Thus, when the banknote collection cassette 42, 42m, 42n is taken out from the banknote handling machine 1 and the banknote collection cassette 42, 42m, 42n is transported, even if the banknotes stacked on the ascending/descending stage 46 are misaligned and one or more of the banknotes on the stacking wheel 44 side are moved toward the banknote passing space 48, the banknote can be inhibited, due to the friction force caused between the banknote and the inhibiting portion 50, 52, 54, 56, 58, from being moved to the upper portion of the banknote passing space 48, with enhanced effectiveness.

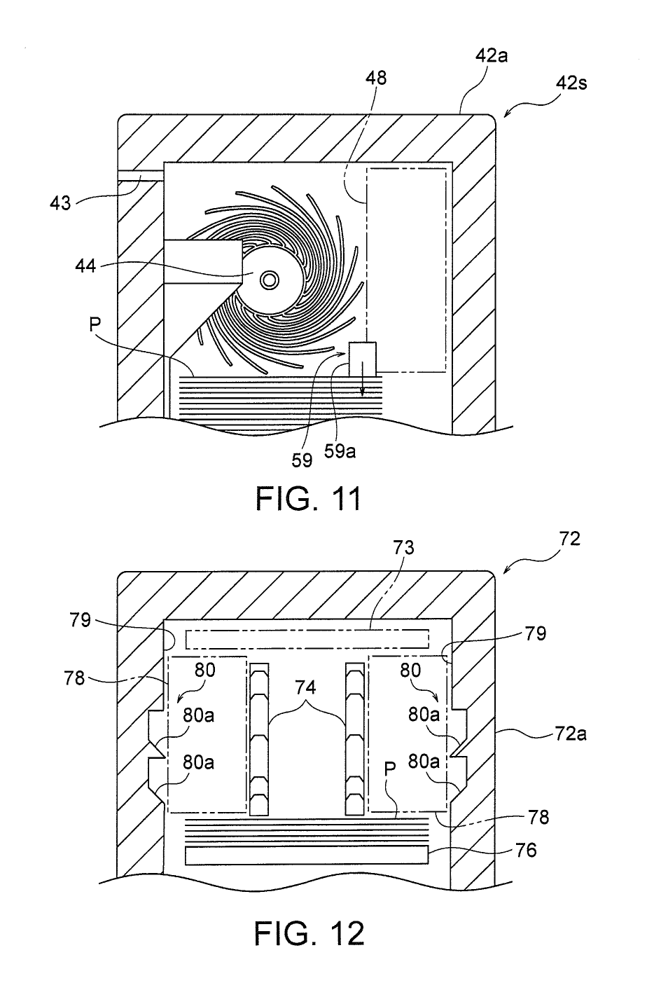

Furthermore, as still another example of the inhibiting portion that inhibits a banknote stacked on the ascending/descending stage 46 from being moved toward the banknote passing space 48, an inhibiting portion that has a pressing member that presses banknotes stacked on the ascending/descending stage 46 in a layered state toward the ascending/descending stage 46, may be used. A structure of the inhibiting portion having such a pressing member will be described with reference to FIG. 11.

In a banknote collection cassette 42s according to another modification shown in FIG. 11, an inhibiting portion 59 has a pressing member 59a that presses banknotes stacked on the ascending/descending stage 46 in a layered state toward the ascending/descending stage 46. When the banknote collection cassette 42s is mounted to the collection unit 40, the pressing member 59a retracts from the banknotes stacked on the ascending/descending stage 46 in a layered state. Meanwhile, when the banknote collection cassette 42s is detached from the collection unit 40, the pressing member 59a presses the banknotes stacked on the ascending/descending stage 46 in a layered state toward the ascending/descending stage 46. In the banknote collection cassette 42s according to another modification shown in FIG. 11, when the banknote collection cassette 42s is taken out from the banknote handling machine 1 and the banknote collection cassette 42s is transported, the banknotes stacked on the ascending/descending stage 46 in a layered state are pressed toward the ascending/descending stage 46 by the pressing member 59a, whereby a state where the banknotes stacked on the ascending/descending stage 46 are misaligned and one or more of the banknotes on the stacking wheel 44 side are moved toward the banknote passing space 48, can be inhibited.

Furthermore, in the banknote collection cassette 42s as described above, the pressing member 59a may include a frictional material, such as rubber, which causes, when a banknote stacked on the ascending/descending stage 46 is moved toward the banknote passing space 48, a high friction force between the frictional material and the banknote. More specifically, a friction force caused between the banknote and the frictional material of the pressing member 59a is higher than a friction force caused between the banknote and a material of the inner wall of the banknote collection cassette 42. Thus, when the banknote collection cassette 42s is taken out from the banknote handling machine 1 and the banknote collection cassette 42s is transported, a state where the banknotes stacked on the ascending/descending stage 46 are misaligned and one or more of the banknotes on the stacking wheel 44 side are moved toward the banknote passing space 48, can be inhibited with enhanced effectiveness.

Next, an operation performed by the money handling system according to the present embodiment will be described. Specifically, operations, performed by the banknote handling machine 1, for banknote depositing, dispensing, and collection will be described below. The operation of the banknote handling machine 1 as described below is performed by the control unit 60 controlling the components of the banknote handling machine 1.

Firstly, an operation, for banknote depositing, performed by the banknote handling machine 1 will be described. When an operator inputs an instruction for starting banknote depositing through the operation/display unit (not shown) and inserts banknotes into the banknote inlet unit 10, the banknotes inserted into the banknote inlet unit 10 are fed one by one into the housing 1a by the plurality of rollers such as the feed rollers and the kicker rollers provided in the banknote inlet unit 10, and the fed banknotes are transported by the transport unit 12. Furthermore, the recognition unit 14 performs recognition of denominations, authenticity, fitness/unfitness, old/new version, face/back, transport state, and the like for the banknotes transported by the transport unit 12.

Banknotes that are determined as normal banknotes on the basis of the result of the recognition by the recognition unit 14 are delivered from the upper assembly 2 to the lower assembly 3 by the transport unit 12, and stored, for each denomination, in the storage/feeding units 20 provided inside the lower assembly 3. Meanwhile, a banknote recognized as a counterfeit note or a suspect note by the recognition unit 14 is transported into the banknote storage unit 19 by the transport unit 12, and stored in the banknote storage unit 19. Thus, both banknotes recognized as counterfeit notes by the recognition unit 14 and banknotes recognized as suspect notes by the recognition unit 14 are stored in the banknote storage unit 19. Furthermore, banknotes of denominations which are not assigned to the storage/feeding units 20, and overflow banknotes which cannot be stored in the storage/feeding unit 20 for the corresponding denomination since the storage/feeding unit 20 therefor is full, are transported into the collection unit 40 by the transport unit 12, and stored inside the banknote collection cassette 42 mounted to the collection unit 40. When all the banknotes are fed from the banknote inlet unit 10 into the housing 1a, and are transported into the storage/feeding units 20, the banknote storage unit 19, or the collection unit 40, the banknote depositing by the banknote handling machine 1 is completed.

Next, an operation, for banknote dispensing, performed by the banknote handling machine 1 will be described. When an operator inputs the number of banknotes to be dispensed for each denomination, the total monetary amount of the banknotes to be dispensed, or the like and inputs an instruction for starting banknote dispensing through the operation/display unit (not shown), banknotes to be dispensed are fed one by one from the storage/feeding units 20 into the transport unit 12, and delivered from the lower assembly 3 to the upper assembly 2 by the transport unit 12. Banknotes that are determined as being not abnormally transported, on the basis of the results of detection by the banknote detection sensors 12a, are transported into the banknote outlet unit 16 and stacked in the banknote outlet unit 16. Furthermore, banknotes (that is, rejected notes in dispensing) that are determined as being abnormally transported, on the basis of the results of detection by the banknote detection sensors 12a, are transported into the banknote storage unit 18 and stored in the banknote storage unit 18. When all the banknotes to be dispensed are transported into the banknote outlet unit 16, and are stacked in the banknote outlet unit 16, the shutter mechanism 17 opens the outlet, for the banknotes, of the banknote outlet unit 16, and the operator is thus allowed to take out the banknotes from the banknote outlet unit 16 to the outside of the housing 1a. Thereafter, when the banknotes are taken out from the banknote outlet unit 16 to the outside of the housing 1a, the shutter mechanism 17 closes again the outlet, for banknotes, of the banknote outlet unit 16. Thus, the banknote dispensing by the banknote handling machine 1 is completed.

Next, an operation, for banknote collection, performed by the banknote handling machine 1 will be described. When a guard of a security transport company, or the like inputs an instruction for stating banknote collection through the operation/display unit (not shown), all the banknotes stored in the storage/feeding units 20 are fed one by one from the storage/feeding units 20 into the transport unit 12, and are transported into the collection unit 40 by the transport unit 12. Specifically, the banknote collection cassette 42 described above, is detachably mounted to the collection unit 40, and the banknotes transported from the storage/feeding units 20 through the transport unit 12 into the collection unit 40 are stored inside the banknote collection cassette 42. When all the banknotes are transported from the storage/feeding units 20 into the collection unit 40, and stored in the banknote collection cassette 42 mounted to the collection unit 40, the guard of the security transport company, or the like opens the door of the lower assembly 3 and takes out the banknote collection cassette 42 from the collection unit 40, whereby the banknotes are collected together with the banknote collection cassette 42 from the banknote handling machine 1. Thus, when the banknote collection cassette 42 in which the banknotes are stored is taken out from the banknote handling machine 1, the banknote collection by the banknote handling machine 1 is completed.

In the banknote collection cassette 42, 42m, 42n, 42s (paper sheet storage cassette), according to the present embodiment, having the above-described structure, the banknote passing space 48 through which banknotes sent onto the ascending/descending stage 46 (stacking unit) by the stacking wheel 44 pass, is formed near the stacking wheel 44 in the banknote collection cassette 42, 42m, 42n, 42s. Furthermore, the inhibiting portion 50, 52, 54, 56, 58, 59 that inhibits a banknote stacked on the ascending/descending stage 46 from being moved toward the banknote passing space 48 (more strictly, upper portion of the banknote passing space 48), is provided. Thus, a banknote stacked on the ascending/descending stage 46 is inhibited from being moved toward the banknote passing space 48 near the stacking wheel 44, whereby the banknotes stacked on the ascending/descending stage 46 in a layered state, can be prevented from being greatly misaligned.

Furthermore, in the banknote collection cassette 42, 42m, 42n, 42s of the present embodiment, the inhibiting portion 50, 52, 54, 56, 58, 59 is disposed in a portion, of the inner wall 49 of the banknote collection cassette 42, 42m, 42n, 42s, which faces the stacking wheel 44. Furthermore, the inhibiting portion 50, 52, 54, 56, 58, 59 is disposed in a portion, of the inner wall 49 of the banknote collection cassette 42, 42m, 42n, 42s, which faces the edge, on the short edge side, of the banknote to be sent onto the ascending/descending stage 46 by the stacking wheel 44. Furthermore, the inhibiting portion 50, 52, 54, 56, 58, 59 is disposed above the lower end of the blade passing region through which the blades 44c of the stacking wheel 44 pass.

Furthermore, in the examples shown in FIG. 3 to FIG. 8, the inhibiting portions 50, 52, 54 have the groove portions 50a, 52a, 54a provided in the inner wall 49 of the banknote collection cassette 42, and at least a part of each of the groove portions 50a, 52a, 54a forms a stepped shape by which the edge of a banknote can be caught when the banknote stacked on the ascending/descending stage 46 is moved toward the banknote passing space 48. In this case, when the banknote collection cassette 42 is taken out from the banknote handling machine 1 and the banknote collection cassette 42 is transported, even if the banknotes stacked on the ascending/descending stage 46 are misaligned and one or more of the banknotes on the stacking wheel 44 side are moved toward the banknote passing space 48, the banknote can be inhibited from being moved to the upper portion of the banknote passing space 48 by the edge of the banknote being caught by the groove portion 50a, 52a, 54a of the inhibiting portion 50, 52, 54. Furthermore, a plurality of the groove portions 50a, a plurality of the groove portions 52a, or a plurality of the groove portions 54a are disposed so as to be aligned along the direction in which banknotes are stacked on the ascending/descending stage 46. The number of the groove portions 50a of the inhibiting portion 50, the number of the groove portions 52a of the inhibiting portion 52, and the number of the groove portions 54a of the inhibiting portion 54 may not be plural. The inhibiting portion 50 may have one groove portion 50a, the inhibiting portion 52 may have one groove portion 52a, and the inhibiting portion 54 may have one groove portion 54a. Furthermore, the groove portions 50a, 52a, 54a may be each formed so as to be a straight line that extends almost parallel to the direction in which the shaft 44a of the stacking wheel 44 extends. Furthermore, the groove portions 50a, 54a include the tilted surfaces 50d, 54c that are tilted relative to the direction in which banknotes are stacked on the ascending/descending stage 46.

Furthermore, in the example shown in FIG. 9, the inhibiting portion 56 has the projection 56a that is provided in the inner wall 49 of the banknote collection cassette 42m, and that projects from the inner wall 49 toward the banknote passing space 48, and at least a part of the projection 56a forms a stepped shape by which the edge of a banknote can be caught when the banknote stacked on the ascending/descending stage 46 is moved toward the banknote passing space 48. In this case, when the banknote collection cassette 42m is taken out from the banknote handling machine 1 and the banknote collection cassette 42m is transported, even if the banknotes stacked on the ascending/descending stage 46 are misaligned and one or more of the banknotes on the stacking wheel 44 side are moved toward the banknote passing space 48, the edge of the banknote can be caught by the projection 56a of the inhibiting portion 56, whereby the banknote can be inhibited from being moved to the upper portion of the banknote passing space 48. Furthermore, a plurality of the projections 56a are disposed so as to be aligned along the direction in which the banknotes are stacked on the ascending/descending stage 46. The number of the projections 56a of the inhibiting portion 56 may not be plural, and the inhibiting portion 56 may have one projection 56a.

Furthermore, in the example shown in FIG. 10, the inhibiting portion 58 has the guide member 58a that is movable between the advanced position at which the guide member 58a advances to the banknote passing space 48 and the retracted position at which the guide member 58a retracts from the banknote passing space 48. When the guide member 58a is positioned at the advanced position, the banknote stacked on the ascending/descending stage 46 is inhibited from being moved toward the banknote passing space 48. In this case, when the banknote collection cassette 42m is taken out from the banknote handling machine 1 and the banknote collection cassette 42m is transported, the guide member 58a positioned at the advanced position inhibits a state where the banknotes stacked on the ascending/descending stage 46 are misaligned and one or more of the banknotes on the stacking wheel 44 side are moved toward the banknote passing space 48.

Furthermore, in the example shown in FIG. 11, the inhibiting portion 59 has the pressing member 59a that presses the banknotes stacked on the ascending/descending stage 46 toward the ascending/descending stage 46. In this case, when the banknote collection cassette 42s is taken out from the banknote handling machine 1 and the banknote collection cassette 42s is transported, banknotes stacked on the ascending/descending stage 46 in a layered state are pressed toward the ascending/descending stage 46 by the pressing member 59a, whereby a state where the banknotes stacked on the ascending/descending stage 46 are misaligned and one or more of the banknotes on the stacking wheel 44 side are moved toward the banknote passing space 48, can be inhibited.

Furthermore, in the present embodiment, when the banknote collection cassette 42, 42m, 42n, 42s is transported, the banknotes stacked on the ascending/descending stage 46 in a layered state, are pressed toward the stacking wheel 44 by the ascending/descending stage 46. In this case, a state where the banknotes stacked on the ascending/descending stage 46 are misaligned and one or more of the banknotes on the stacking wheel 44 side are moved toward the banknote passing space 48, can be inhibited with enhanced effectiveness.

The banknote collection cassette according to the present embodiment is not limited to one having the above-described structure, and various modifications thereto can be made.

For example, the inhibiting portion that inhibits a banknote stacked on the ascending/descending stage 46 from being moved toward the banknote passing space 48 is not limited to the inhibiting portion structured so as to have the above-described groove portion, projection, or the like. The inhibiting portion may have a structure other than the structures described above when the structure inhibits a banknote stacked on the ascending/descending stage 46 from being moved toward the banknote passing space 48.

Furthermore, the principle of the present invention may be applied to a banknote collection cassette into which banknotes are inserted from the outside along their short edges, instead of the banknote collection cassette into which banknotes are inserted from the outside along their long edges. The structure of the banknote collection cassette according to the modification will be described in detail with reference to FIG. 12.

As shown in FIG. 12, a banknote collection cassette 72 according to the modification includes: a casing 72a that is almost rectangular-parallelepiped-shaped; and an inlet 73 through which banknotes are inserted into the casing 72a from the outside. The inlet 73 is formed in the upper portion of the side surface of the casing 72a. In the banknote collection cassette 72 according to the modification, the inlet 73 extends in the left-right direction in FIG. 12. When the banknote collection cassette 72 is mounted to the collection unit, banknotes transported from the transport unit of the body portion of the banknote handling machine to the collection unit are inserted through the inlet 73 into the casing 72a of the banknote collection cassette 72. In the example shown in FIG. 12, in the transport unit of the body portion of the banknote handling machine, the banknotes are transported along their short edges, and the banknotes are transported along their short edges through the inlet 73 of the banknote collection cassette 72 into the casing 72a. That is, the long edges of the banknotes inserted through the inlet 73 into the banknote collection cassette 72 in FIG. 12 extend in the left-right direction in FIG. 12. Furthermore, an ascending/descending stage 76 (stacking unit) on which banknotes inserted into the casing 72a through the inlet 73 from the outside are stacked in a layered state is provided in the casing 72a. The ascending/descending stage 76 is moved along the direction (that is, in the up-down direction in FIG. 12) in which the banknotes are stacked. More specifically, each time a banknote is stacked on the ascending/descending stage 76, the ascending/descending stage 76 descends over a short distance. Thus, a space in which banknotes are stacked is formed between the ascending/descending stage 76 and stacking wheels 74 described below.

Furthermore, as shown in FIG. 12, paired left and right stacking wheels 74 for sending banknotes inserted through the inlet 73 into the casing 72a from the outside, one by one, onto the ascending/descending stage 76 are provided in an upper region of the inside of the casing 72a. More specifically, the paired left and right stacking wheels 74 rotate about an axis that extends in the left-right direction in FIG. 12 in synchronization with each other. Furthermore, each stacking wheel 74 includes: a base body that rotates about a shaft; and a plurality of blades that extend outward from the outer circumferential surface of the base body in a direction opposite to a direction of rotation of the base body. The blades are equally spaced from each other on the outer circumferential surface of the base body. In the stacking wheels 74, a banknote transported from the inlet 73 is received between two blades, and the banknote received between the blades is sent onto the ascending/descending stage 76. The stacking wheels 74 thus allow banknotes to be stacked on the ascending/descending stage 76 in an aligned state.

As shown in FIG. 12, banknote passing spaces 78 through which a banknote to be sent onto the ascending/descending stage 76 by the stacking wheels 74 passes, are formed between the stacking wheels 74 and paired left and right inner walls 79 which are among the inner walls positioned lateral to an internal space of the casing 72a and which face the stacking wheels 74, respectively. Furthermore, in the example shown in FIG. 12, paired left and right inhibiting portions 80 are provided which inhibit a banknote stacked on the ascending/descending stage 76 from being moved toward the upper portion of the banknote passing space 78 when the banknote collection cassette 72 is taken out from the banknote handling machine 1 and the banknote collection cassette 72 is transported.

The inhibiting portions 80 are disposed in portions, facing the stacking wheels 74, of the inner walls 79 which are among the inner walls of the casing 72a and which face the stacking wheels 74, respectively. More specifically, each inhibiting portion 80 has a plurality (specifically, for example, two) of groove portions 80a that are aligned along a direction (specifically, the up-down direction in FIG. 12) in which banknotes are stacked on the ascending/descending stage 76. At least a part of each groove portion 80a forms a stepped shape by which the edge of a banknote can be caught when the banknote stacked on the ascending/descending stage 76 is moved toward the banknote passing space 78. Furthermore, each groove portion 80a is formed so as to be a straight line that extends in the direction orthogonal to the sheet surface of FIG. 12. Specifically, each groove portion 80a extends over the entire length of an internal region of the casing 72a in the direction orthogonal to the sheet surface of FIG. 12.

In a case where the inhibiting portions 80 are thus provided in the inner walls 79 of the casing 72a, when the banknote collection cassette 72 is taken out from the banknote handling machine and the banknote collection cassette 72 is transported, a banknote stacked on the ascending/descending stage 76 can be inhibited from being moved toward the banknote passing space 78. This will be described below.

When the banknote collection cassette 72 is taken out from the banknote handling machine and the banknote collection cassette 72 is transported, the ascending/descending stage 76 is moved upward, and banknotes stacked on the ascending/descending stage 76 in a layered state is thus pressed toward the stacking wheels 74. Thus, when the banknote collection cassette 72 is transported, a plurality of banknotes in the layered state are sandwiched and pressed between the stacking wheels 74 and the ascending/descending stage 76. Therefore, the banknotes stacked on the ascending/descending stage 76 can be inhibited from being misaligned and stacked in the misaligned state. However, even when a plurality of banknotes in the layered state are thus sandwiched and pressed between the stacking wheels 74 and the ascending/descending stage 76, banknotes (in particular, one or more of the banknotes on the stacking wheel 74 side) stacked on the ascending/descending stage 76 are misaligned in the left-right direction in FIG. 12, and stacked in the misaligned state in some cases. Meanwhile, in the example shown in FIG. 12, the inhibiting portions 80 are provided in the inner walls 79, respectively, of the casing 72a. Therefore, even when the banknotes stacked on the ascending/descending stage 76 are misaligned in the left-right direction in FIG. 12 and one or more of the banknotes on the stacking wheel 74 side are moved toward the banknote passing space 78, the edge of such a banknote can be caught by the groove portions 80a of the inhibiting portions 80, whereby the banknote can be inhibited from being moved to the upper portion of the banknote passing space 78.

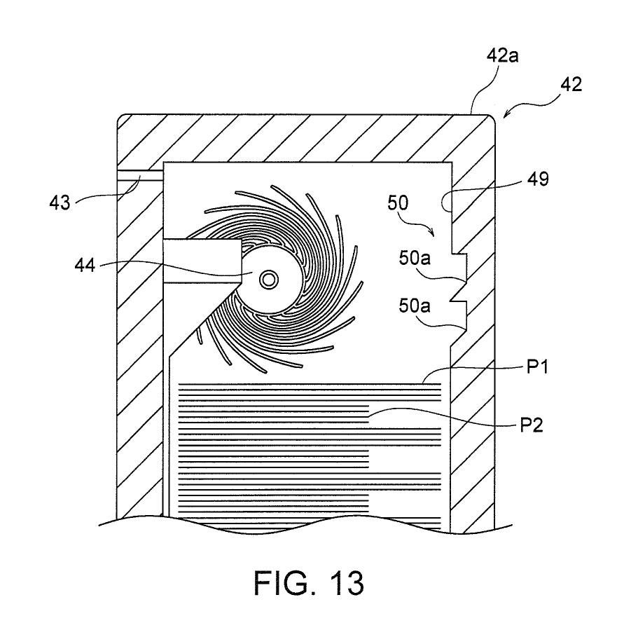

Furthermore, in the banknote handling machine 1 shown in FIG. 1 to FIG. 5 and the like, in a case where banknotes are collected, when plural kinds of banknotes having different lengths (specifically, banknotes of different denominations or banknotes issued in different countries and the like) are fed from the storage/feeding units 20 and transported into the collection unit 40, an operation of transporting, into the banknote collection cassette 42, a predetermined number of banknotes (for example, several tens of banknotes) each having a certain banknote length, and thereafter transporting, into the banknote collection cassette 42, a predetermined number of banknotes (for example, several tens of banknotes) each having another banknote length, may be repeated. In this case, as shown in FIG. 13, a predetermined number of banknotes P1 each having a long banknote length and a predetermined number of banknotes P2 each having a short banknote length are alternately stacked on the ascending/descending stage 46. In a case where banknotes are thus stacked on the ascending/descending stage 46, when the banknote collection cassette 42 is taken out from the banknote handling machine 1 and the banknote collection cassette 42 is transported, banknotes, each having the short banknote length, which are stacked on the ascending/descending stage 46 can be inhibited from being laterally displaced and greatly misaligned. More specifically, in a case where a lot of banknotes each having a short banknote length are stacked on the ascending/descending stage 46, since a large space is formed between the edges of the banknotes and the inner wall 49 of the casing 42a, if the banknotes, each having the short banknote length, which are stacked on the ascending/descending stage 46 are laterally displaced, the banknotes enter the space and are thus raised, and the banknotes are greatly misaligned. Meanwhile, as shown in FIG. 13, in a case where the predetermined number of banknotes P1 each having a long banknote length and the predetermined number of banknotes P2 each having a short banknote length are alternately stacked on the ascending/descending stage 46, a large space is not formed between the edges of the banknotes stacked on the ascending/descending stage 46 and the inner wall 49 of the casing 42a. Therefore, even if the banknotes, each having the short banknote length, which are stacked on the ascending/descending stage 46 are laterally displaced, the banknotes can be inhibited from being raised. Thus, in a case where a predetermined number of banknotes P1 each having a long banknote length and a predetermined number of banknotes P2 each having a short banknote length are alternately stacked on the ascending/descending stage 46, when the banknote collection cassette 42 is transported, the banknotes stacked on the ascending/descending stage 46 in a layered state can be prevented from being misaligned.

Furthermore, a case where the inhibiting portion inhibits banknotes stacked on a stacking unit such as the ascending/descending stage from being moved toward the banknote passing space in the banknote collection cassette used for collecting banknotes, is described above. However, an inhibiting portion having the same structure as the inhibiting portion described above may be provided in a cassette (for example, banknote storage cassette) other than a banknote collection cassette when the cassette is portable and allows banknotes to be stacked on a stacking unit in a layered state.

Furthermore, the present invention is not limited to a cassette (for example, banknote collection cassette) that is portable and allows banknotes to be stacked on a stacking unit in a layered state. In the present invention, the principle of the banknote collection cassette 42, 42m, 42n, 42s described above may be applied to paper sheet storage cassettes that is portable and allow paper sheets (for example, checks or gift coupons) other than banknotes to be stored in a layered state. That is, in a paper sheet storage cassette that is portable, an inhibiting portion that inhibits a paper sheet stacked on a stacking unit from being moved toward a paper sheet passing space may be provided in the paper sheet passing space through which paper sheets, which are to be sent into the stacking unit such as an ascending/descending stage by a stacking wheel, pass. In this case, the inhibiting portion inhibits a paper sheet stacked on the stacking unit from being moved toward the upper portion of the paper sheet passing space near the stacking wheel, whereby the paper sheets stacked on the stacking unit in a layered state can be prevented from being greatly misaligned during carrying operation.

What is claimed is:

1. A paper sheet storage cassette that is portable, the paper sheet storage cassette comprising:
an inlet, provided in the paper sheet storage cassette, through which a paper sheet is inserted into the paper sheet storage cassette from the outside;
a stacking unit, provided inside the paper sheet storage cassette, on which paper sheets inserted through the inlet into the paper sheet storage cassette from the outside are stacked in a layered state, the stacking unit configured to move along a direction in which the paper sheets are stacked; and
a stacking wheel configured to send paper sheets inserted through the inlet into the paper sheet storage cassette from the outside, one by one, to the stacking unit, the stacking wheel including a base body that rotates about a shaft, and a plurality of blades which extend outward from an outer circumferential surface of the base body in a direction opposite to a direction of rotation of the base body, the stacking wheel configured to send paper sheets stored between the blades into the stacking unit, wherein
a paper sheet passing space through which paper sheets to be sent into the stacking unit by the stacking wheel pass, the paper sheet passing space being formed near the stacking wheel inside the paper sheet storage cassette; and
an inhibiting portion configured to inhibit a paper sheet stacked on the stacking unit from being moved toward the paper sheet passing space.

2. The paper sheet storage cassette according to claim 1, wherein the inhibiting portion is provided in a portion facing the stacking wheel, of an inner wall of the paper sheet storage cassette.

3. The paper sheet storage cassette according to claim 1, wherein the inhibiting portion is provided in a portion, of the inner wall of the paper sheet storage cassette, which faces an edge, on a short edge side, of a paper sheet to be sent into the stacking unit by the stacking wheel.

4. The paper sheet storage cassette according to claim 1, wherein the inhibiting portion is disposed above a lower end of a blade passing region through which each blade of the stacking wheel passes.

5. The paper sheet storage cassette according to claim 1, wherein the inhibiting portion has one or more groove portions formed in the inner wall of the paper sheet storage cassette, and at least a part of each of the one or more groove portions form a stepped shape by which an edge of a paper sheet can be caught when the paper sheet stacked in the stacking unit is moved toward the paper sheet passing space.

6. The paper sheet storage cassette according to claim 5, wherein the one or more groove portions are provided so as to be aligned along a direction in which paper sheets are stacked in the stacking unit.

7. The paper sheet storage cassette according to claim 5, wherein the one or more groove portions are each formed so as to be a straight line that extends almost parallel to a direction in which the shaft of the stacking wheel extends.

8. The paper sheet storage cassette according to claim 5, wherein the one or more groove portions each include a tilted surface that is tilted relative to a direction in which paper sheets are stacked in the stacking unit.

9. The paper sheet storage cassette according to claim 1, wherein the inhibiting portion has a projection that is disposed on the inner wall of the paper sheet storage cassette, and that projects from the inner wall toward the paper sheet passing space, and at least a part of the projection forms a stepped shape by which an edge of a paper sheet can be caught when the paper sheet stacked on the stacking unit is moved toward the paper sheet passing space.

10. The paper sheet storage cassette according to claim 9, wherein a plurality of the projections are provided so as to be aligned along a direction in which paper sheets are stacked in the stacking unit.

11. The paper sheet storage cassette according to claim 1, wherein the inhibiting portion has a guide member that is movable between an advanced position at which the guide member advances to the paper sheet passing space and a retracted position at which the guide member retracts from the paper sheet passing space, and the guide member inhibits a paper sheet stacked in the stacking unit from being moved toward the paper sheet passing space when the guide member is positioned at the advanced position.

12. The paper sheet storage cassette according to claim 5, wherein the inhibiting portion comprises a frictional material that causes a friction force such that, when a paper sheet stacked in the stacking unit is moved toward the paper sheet passing space, the friction force caused between the paper sheet and the frictional material is higher than a friction force caused between the paper sheet and a material of the inner wall of the paper sheet storage cassette.

13. The paper sheet storage cassette according to claim 1, wherein the inhibiting portion has a pressing member that presses paper sheets stacked in the stacking unit in a layered state toward the stacking unit.

14. The paper sheet storage cassette according to claim 13, wherein the pressing member comprises a frictional material that causes a friction force such that a friction force caused between the frictional material and one or more paper sheets stacked in the stacking unit and pressed by the pressing member is higher than a friction force caused between a material of the inner wall of the paper sheet storage cassette, and the one or more paper sheet pressed by the pressing member.

15. The paper sheet storage cassette according to claim 1, wherein paper sheets stacked in the stacking unit in a layered state are pressed by the stacking unit toward the stacking wheel when the paper sheet storage cassette is transported.

16. A paper sheet handling machine to which the paper sheet storage cassette according to claim 1 is detachably mounted, wherein a paper sheet is transported through the inlet of the paper sheet storage cassette from the paper sheet handling machine into the paper sheet storage cassette.
